(19) United States
(12) Patent Application Publication
(10) Pub. No.: US 2026/0281808 A1
(43) Pub. Date: Sep. 17, 2026

(54) PROTOCOL DATA UNIT (PDU) SET DROPPING BASED ON PDU SET IMPORTANCE (PSI) SIGNALING, CONFIGURATION, AND USER EQUIPMENT (UE) BEHAVIOR

(71) Applicant: Telefonaktiebolaget LM Ericsson (publ), Stockholm (SE)

(72) Inventors: Jose Luis PRADAS, Stockholm (SE); Richard TANO, Stockholm (SE); Du Ho KANG, Sollentuna (SE)

(21) Appl. No.: 19/472,175

(22) PCT Filed: Apr. 5, 2024
(86) PCT No.: PCT/EP2024/059402

§ 371 Date: Oct. 3, 2025

Related U.S. Application Data
(60) Provisional application No. 63/494,642, filed on Apr. 6, 2023.

(51) Int. Cl. H04W 28/06; H04L 47/28; H04L 47/32

(52) U.S. Cl. CPC H04W 28/06; H04L 47/28; H04L 47/32

(57) ABSTRACT

A method, system and apparatus are disclosed. According to some embodiments, a method implemented by a wireless device that is configured to communicate with a network node is provided. The method includes receiving a first indication of a first PDU Set discard timer value for discarding a first PDU set, where the first PDU Set discard timer: is associated with at least a first PSI level, and is different from a PDCP discard timer and/or has the PDU Set discard timer value different from a PDCP discard timer value, and communicating with the network node according to the first indication.

### TECHNICAL FIELD

The present disclosure relates to wireless communications, and in particular, to wireless device behavior related to discarding protocol data unit (PDU) Set(s).

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks.

In particular, 5G is the fifth generation of mobile communications, addressing a wide range of use cases from enhanced mobile broadband (eMBB) to ultra-reliable low-latency communications (URLLC) to massive machine type communications (mMTC). 5G includes the New Radio (NR) access stratum interface and the 5G Core Network (5GC). The NR physical and higher layers are reusing parts of the LTE specification, and to that add needed components when motivated by new use cases.

Low-latency high-rate applications such as extended Reality (XR) and cloud gaming are important in the 5G era. XR may refer to all real-and-virtual combined environments and human-machine interactions generated by computer technology and wearables. It is an umbrella term for different types of realities including Virtual reality (VR), Augmented reality (AR), Mixed reality (MR), and the areas interpolated among them. The levels of virtuality range from partially sensory inputs to fully immersive VR.

5G NR is designed to support applications demanding high rate and low latency in line with the requirements posed by the support of XR and cloud gaming applications in NR networks. 3GPP Release 17 contains a study item on XR Evaluations for NR. Some objectives of this study are to identify the traffic model for each application of interest, the evaluation methodology and the key performance indicators of interest for relevant deployment scenarios, and to carry out performance evaluations accordingly in order to investigate possible standardization enhancements in potential follow-up study item/work item (SI/WI).

### Low-Latency High-Rate XR Applications

The low-latency applications like XR and cloud gaming may require bounded latency, not necessarily ultra-low latency. The end-to-end latency budget may be in the range of 20-80 ms, which may need to be distributed over several components including application processing latency, transport latency, radio link latency, etc. For these applications, short transmission time intervals (TTIs) or mini-slots targeting ultra-low latency may not be effective.

FIG. 1 is a diagram of an example of frame latency measured over radio access network (RAN), excluding application & core network latencies. As illustrated in FIG. 1, there exist frame latency spikes in RAN. The sources for the latency spikes may include queuing delay, time-varying radio environments, time-varying frame sizes, among others. For example, latency spikes may occur due to instantaneous shortage of radio resources or inefficient radio resource allocation in response to varying frame size. Tools that can help to remove latency spikes are beneficial to enable better 5G support for this type of traffic.

In addition to bounded latency requirements, the applications like XR and cloud gaming also require high rate transmission. This can be seen from the large frame sizes originated from this type of traffic. The typical frame sizes may range from tens of kilobytes to hundreds of kilobytes. The frame arrival rates may be 60 or 120 frames per second (fps). As one example, a frame size of 100 kilobytes and a frame arrival rate of 120 fps can lead to a rate requirement of 95.8 Mbps.

A large video frame is usually fragmented into smaller IP packets and transmitted as several transport blocks (TBs) over several TTIs in RAN. FIG. 2 is an example of the cumulative distribution functions of the number of transport blocks required to deliver a video frame with size ranging from 20 KB to 300 KB. For example, FIG. 2 illustrates that for delivering the frames with a size of 200 KB each, the median number of needed TBs is 5.

The characteristics of XR traffic arrival are quite distinct from typical web-browsing and VoIP traffic as shown in FIG. 3. It may be expected that, in XR traffic, the arrival time is quasi-periodic and largely predictable similar to VoIP. However, its data size is order of magnitude larger than VoIP, as discussed above. In addition, similar to web-browsing, the data size in XR traffic is different at every application PDU (e.g., protocol data unit) arrival instance due to dynamics of contents and human motion.

As described above, many XR applications will generate traffic periodically with a variable size. When the application packet enters the internet, the initial packet may be transmitted into a single PDU in the network or may be segmented several PDUs. One application packet could, for instance, correspond to one or several IP packets.

IP packets will arrive to the Packet Data Convergence Protocol (PDCP) layer, i.e., PDCP SDUs (e.g., service data units), and the PDCP layer will create PDCP PDUs and will deliver then to lower layers (e.g., lower network layers). When an IP packet arrives to PDCP, the PDCP layer starts a PDCP discard timer. When this timer expires, the PDCP discards the PDCP SDU as well as the corresponding PDCP Data PDU. If the PDCP PDU was delivered to lower layers, PDCP indicates the discard to lower layers. Lower layers, e.g., RLC will discard the PDCP PDUs (radio link control (RLC) SDU) if these RLC SDU or any segment of the RLC SDU has not yet been transmitted to lower layers.

As discussed above, an application PDU, e.g., a video frame, is divided into multiple IP packets. All these IP packets which belong to one video frame can be defined as PDU Set.

SA2 in, for example, 23700-60, identified that PDU sets could be assigned with a PDU Set Importance indicator. This parameter can be used to identify the importance of a PDU Set within a QoS flow. RAN may use it for PDU Set level packet discarding in presence of congestion.

*PDU Set as defined by 3GPP 23.700-60: PDU Set: A PDU Set is composed of one or more PDUs carrying the payload of one unit of information generated at the application level (e.g., a frame or video slice for XRM Services, as used in 3GPP Technical reference (TR) 26.926). In some implementations, all PDUs in a PDU Set are needed by the application layer to use the corresponding unit of information. In other implementations, the application layer can still recover parts all or of the information unit, when some PDUs are missing.

### SUMMARY

Some embodiments advantageously provide methods, systems, and apparatuses for wireless device behavior related to discarding protocol data unit (PDU) Set(s).

The present disclosure provides 1) signaling to configure the wireless device, 2) additional signaling to activate and deactivate the feature, 3) wireless device behavior when the feature is configured and activated or deactivated.

To address 1) an radio resource control (RRC) signaling may be used. To address 2), both RRC and lower layer signaling may be used. To address 3), different alternatives are described for how the wireless device can handle the wireless device timers for dropping/discarding PDU set and/or the PDCP discard timer.

According to one aspect of the present disclosure, a method implemented by a wireless device that is configured to communicate with a network node is provided. A first indication of a first protocol data unit, PDU, Set discard timer value for discarding a first PDU set is received where the first PDU Set discard timer: is associated with at least a first PDU set importance, PSI, level, and is different from a packet data convergence protocol, PDCP, discard timer and/or has the PDU Set discard timer value different from a PDCP discard timer value. Communication with the network node is performed according to the first indication.

According to one or more embodiments of this aspect, a second indication is received where the second indication is configured to one of activate or deactivate the PDU Set discard timer functionality that is associated with the first indication.

According to one or more embodiments of this aspect, the second indication is received via one of: a PDCP control element; or Layer 1 signaling.

According to one or more embodiments of this aspect, the second indication is received via a medium access control, MAC, control element, CE.

According to one or more embodiments of this aspect, the second indication indicates a plurality of PDU Set discard timer values for use with a PSI level.

According to one or more embodiments of this aspect, the second indication indicates a plurality of PSI levels that use the first PDU Set discard timer value.

According to one or more embodiments of this aspect, the first indication is an explicit indication that assigns the first PDU Set discard timer value to at least the first PSI level.

According to one or more embodiments of this aspect, the first indication is an implicit indication that assigns the first PDU Set discard timer value to at least the first PSI level by omitting an explicit assignment from the first indication.

According to one or more embodiments of this aspect, an indication of at least one PSI level supported by the wireless device is transmitted.

According to one or more embodiments of this aspect, the first PDU Set discard timer value is configured to use with a specific data radio bearer, DRB, a PDCP, or service.

According to one or more embodiments of this aspect, the first PDU Set discard timer value is configured for use with a plurality of data radio bearers, DRBs, or a plurality of services.

According to another aspect of the present disclosure, a wireless device configured to communicate with a network node is provided. The wireless device is configured to: receive a first indication of a first protocol data unit, PDU, Set discard timer value for discarding a first PDU set, where the first PDU Set discard timer: is associated with at least a first PDU set importance, PSI, level, and is different from a packet data convergence protocol, PDCP, discard timer and/or has the PDU Set discard timer value different from a PDCP discard timer value, and communicate with the network node according to the first indication.

According to one or more embodiments of this aspect, the wireless device is further configured to receive a second indication, where the second indication is configured to one of activate or deactivate the PDU Set discard timer functionality that is associated with the first indication.

According to one or more embodiments of this aspect, the second indication is received via one of: a PDCP control element; or Layer 1 signaling.

According to one or more embodiments of this aspect, the second indication is received via a medium access control, MAC, control element, CE.

According to one or more embodiments of this aspect, the second indication indicates a plurality of PDU Set discard timer values for use with a PSI level.

According to one or more embodiments of this aspect, the second indication indicates a plurality of PSI levels that use the first PDU Set discard timer value.

According to one or more embodiments of this aspect, the first indication is an explicit indication that assigns the first PDU Set discard timer value to at least the first PSI level.

According to one or more embodiments of this aspect, the first indication is an implicit indication that assigns the first PDU Set discard timer value to at least the first PSI level by omitting an explicit assignment from the first indication.

According to one or more embodiments of this aspect, the wireless device is further configured to transmit an indication of at least one PSI level supported by the wireless device.

According to one or more embodiments of this aspect, the first PDU Set discard timer value is configured to use with a specific data radio bearer, DRB, a PDCP, or service.

According to one or more embodiments of this aspect, the first PDU Set discard timer value is configured for use with a plurality of data radio bearers, DRBs, or a plurality of services.

According to another aspect of the present disclosure, a method network node configured to communicate with a wireless device is provided. A first indication of a first protocol data unit, PDU, Set discard timer value for discarding a first PDU set is signaled where the first PDU Set discard timer: is associated with at least a first PDU set importance, PSI, level, and is different from a packet data convergence protocol, PDCP, discard timer and/or has the PDU Set discard timer value different from a PDCP discard timer value. Communication with the wireless device is performed according to the first indication.

According to one or more embodiments of this aspect, signaling a second indication to the wireless device where the second indication is configured to one of activate or deactivate the PDU Set discard timer functionality that is associated with the first indication.

According to one or more embodiments of this aspect, the second indication is provided by one of: a Packet Data Convergence Protocol, PDCP, control element; or Layer 1 signaling.

According to one or more embodiments of this aspect, the second indication is provided by a medium access control, MAC, control element, CE.

According to one or more embodiments of this aspect, the second indication indicates a plurality of PDU Set discard timer values for use with a PSI level, the plurality of PDU Set discard timer values comprising the first PDU Set discard timer value.

According to one or more embodiments of this aspect, the second indication indicates a plurality of PSI levels that use the first PDU Set discard timer value.

According to one or more embodiments of this aspect, the first indication is an explicit indication that assigns the first PDU Set discard timer value to at least the first PSI level.

According to one or more embodiments of this aspect, the first indication is an implicit indication that that assigns the first PDU Set discard timer value to at least the first PSI level by omitting an explicit assignment from the first indication.

According to one or more embodiments of this aspect, an indication of at least one PSI level supported by the wireless device is received.

According to one or more embodiments of this aspect, the first PDU Set discard timer value is configured for use with a specific data radio bearer, DRB, PDCP, or service.

According to one or more embodiments of this aspect, the first PDU Set discard timer value is configured for use with a plurality of data radio bearers, DRBs, or a plurality of services.

According to another aspect of the present disclosure, a network node configured to communicate with a wireless device is provided. The network node is configured to: signal a first indication of a first protocol data unit, PDU, Set discard timer value for discarding a first PDU set, where the first PDU Set discard timer: is associated with at least a first PDU set importance, PSI, level, and is different from a packet data convergence protocol, PDCP, discard timer and/or has the PDU Set discard timer value different from a PDCP discard timer value, and communicate with the wireless device according to the first indication.

According to one or more embodiments of this aspect, the network node is further configured to signal a second indication to the wireless device, where the second indication is configured to one of activate or deactivate the PDU Set discard timer functionality that is associated with the first indication.

According to one or more embodiments of this aspect, the second indication is provided by one of: a Packet Data Convergence Protocol, PDCP, control element; or Layer 1 signaling.

According to one or more embodiments of this aspect, the second indication is provided by a medium access control, MAC, control element, CE.

According to one or more embodiments of this aspect, the second indication indicates a plurality of PDU Set discard timer values for use with a PSI level, where the plurality of PDU Set discard timer values comprises the first PDU Set discard timer value.

According to one or more embodiments of this aspect, the second indication indicates a plurality of PSI levels that use the first PDU Set discard timer value.

According to one or more embodiments of this aspect, the first indication is an explicit indication that assigns the first PDU Set discard timer value to at least the first PSI level.

According to one or more embodiments of this aspect, the first indication is an implicit indication that that assigns the first PDU Set discard timer value to at least the first PSI level by omitting an explicit assignment from the first indication.

According to one or more embodiments of this aspect, the network node is further configured to receive an indication of at least one PSI level supported by the wireless device.

According to one or more embodiments of this aspect, the first PDU Set discard timer value is configured for use with a specific data radio bearer, DRB, PDCP, or service.

According to one or more embodiments of this aspect, the first PDU Set discard timer value is configured for use with a plurality of data radio bearers, DRBs, or a plurality of services.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a diagram of an example of frame latency measured over RAN;

FIG. 2 is a diagram of an example of cumulative distribution functions of a number of transport blocks;

FIG. 3 is a diagram of an example of XR traffic characteristics compared to VoIP and web-browsing;

FIG. 4 is a schematic diagram of an example network architecture illustrating a communication system connected via an intermediate network to a host computer according to the principles in the present disclosure;

FIG. 5 is a block diagram of a host computer communicating via a network node with a wireless device over an at least partially wireless connection according to some embodiments of the present disclosure;

FIG. 6 is a flowchart illustrating example methods implemented in a communication system including a host computer, a network node and a wireless device for executing a client application at a wireless device according to some embodiments of the present disclosure;

FIG. 7 is a flowchart illustrating example methods implemented in a communication system including a host computer, a network node and a wireless device for receiving user data at a wireless device according to some embodiments of the present disclosure;

FIG. 8 is a flowchart illustrating example methods implemented in a communication system including a host computer, a network node and a wireless device for receiving user data from the wireless device at a host computer according to some embodiments of the present disclosure;

FIG. 9 is a flowchart illustrating example methods implemented in a communication system including a host computer, a network node and a wireless device for receiving user data at a host computer according to some embodiments of the present disclosure;

FIG. 10 is a flowchart of an example process in a network node according to some embodiments of the present disclosure;

FIG. 11 is a flowchart of another example process in a network node according to some embodiments of the present disclosure;

FIG. 12 is a flowchart of an example process in a wireless device according to some embodiments of the present disclosure; and

FIG. 13 is a flowchart of another example process in a wireless device according to some embodiments of the present disclosure.

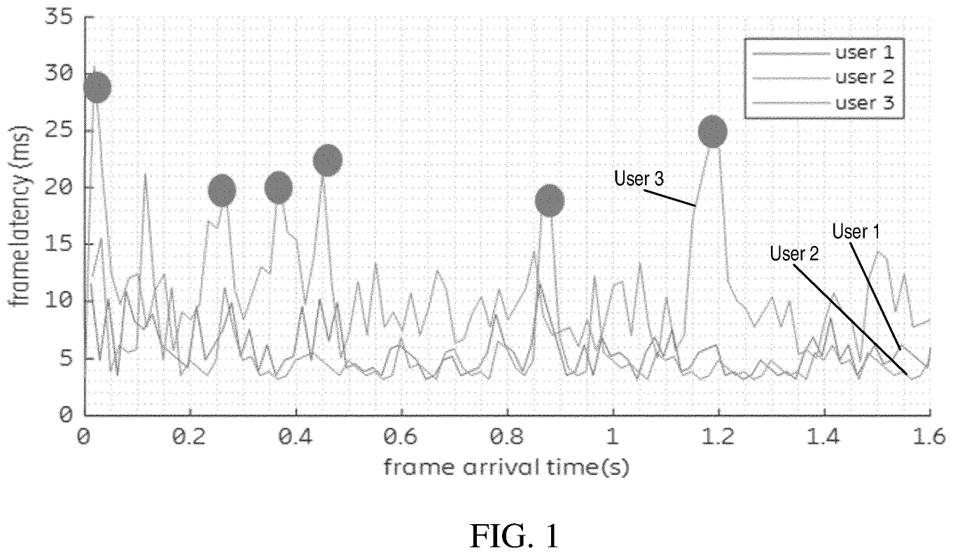

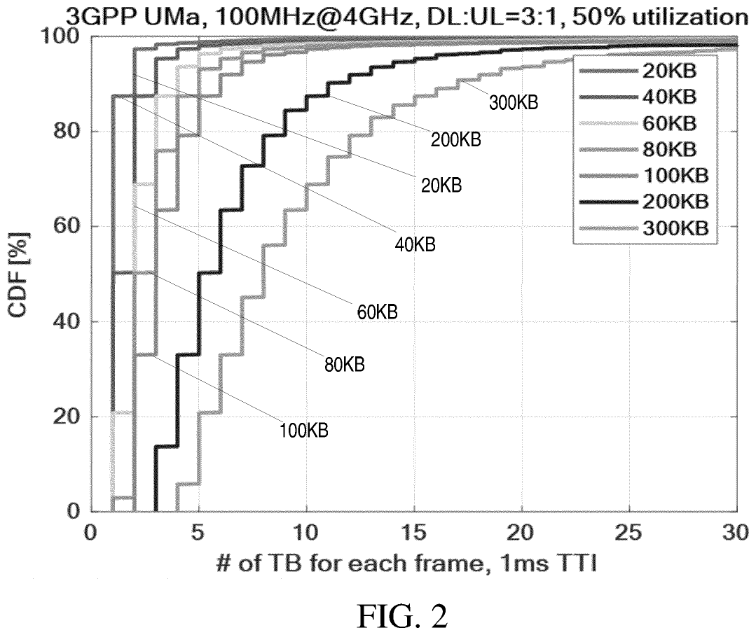

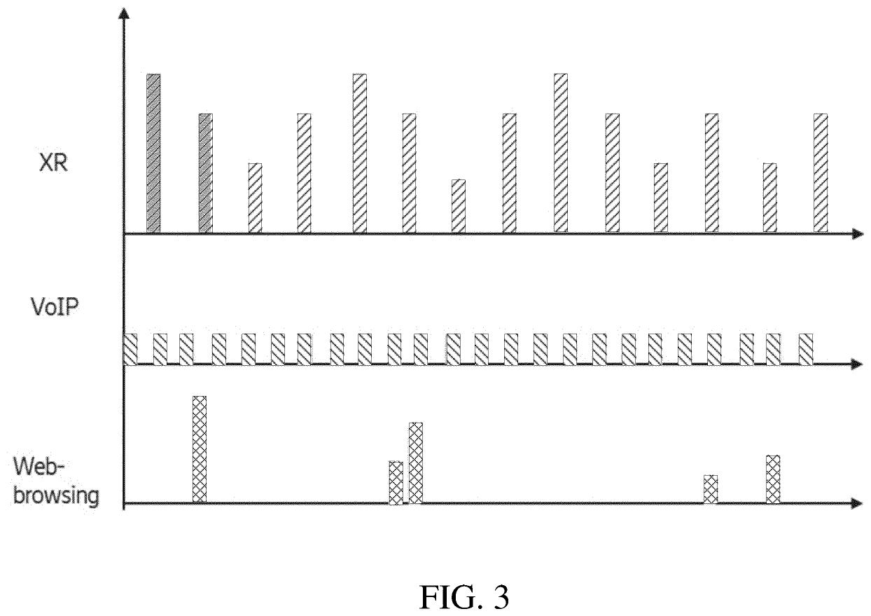

### DETAILED DESCRIPTION

A “PDU Set Importance” (PSI) indicator may be defined where the PSI indicates a certain importance level for the PDU Set. PSI may be used by the network and the wireless device to drop packets under certain circumstances or situations. PSI and PDU set dropping interaction needs to be specified.

In congestion situations there may be a benefit of dropping certain packets from certain users (UEs) to alleviate the network load and increase the overall performance of the network. However all packets from all traffic flows may not be needed to be dropped. In the downlink (DL), the network can select specifically which packets to drop from each data radio bearer (DRB) but in the uplink (UL) there is currently no way for the network, such as by the network node, to specify which packets should be dropped from a wireless device unless all packets from the wireless device are dropped through a flushing process.

The present disclosure solves at least one problem noted above by, at least in part, providing 1) signaling to configure the wireless device, 2) additional signaling to activate and deactivate the feature, 3) wireless device behavior when the feature is configured and activated or deactivated.

To address 1) an radio resource control (RRC) signaling may be used. To address 2), both RRC and lower layer signaling may be used. To address 3), different alternatives are described for how the wireless device can handle the wireless device timers for dropping/discarding PDU set and/or the PDCP discard timer.

Before describing in detail example embodiments, it is noted that the embodiments reside primarily in combinations of apparatus components and processing steps related to wireless device behavior related to discarding protocol data unit (PDU) Set(s). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IoT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The terms discard/discarding and drop/dropping may be used inter-changeably herein.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide wireless device behavior related to discarding protocol data unit (PDU) Set(s).

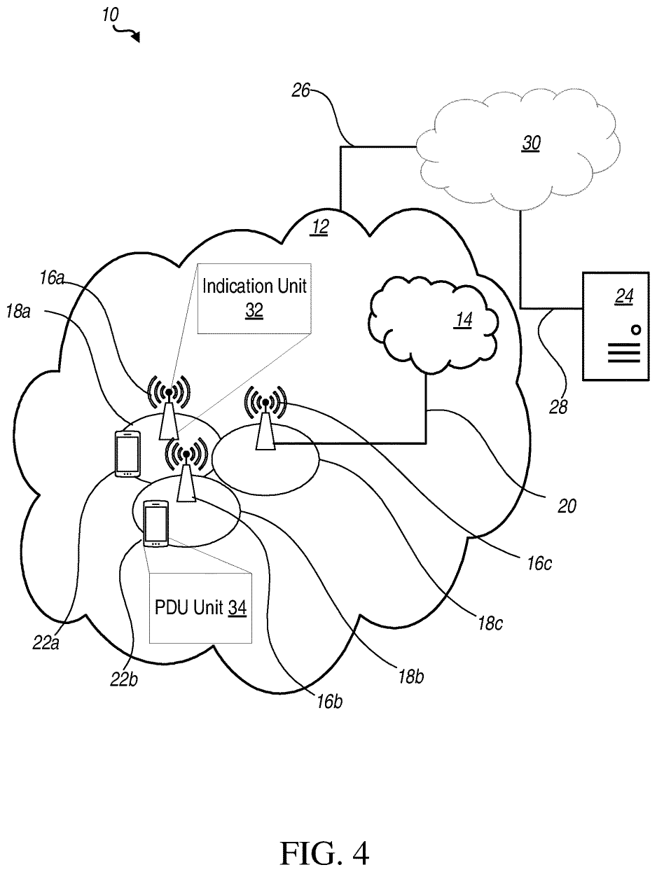

Referring again to the drawing figures, in which like elements are referred to by like reference numerals, there is shown in FIG. 4 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 4 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an indication unit 32 which is configured to perform one or more network node 16 functions as described herein such as with respect to wireless device behavior related to discarding protocol data unit (PDU) Set(s). A wireless device 22 is configured to include a PDU unit 34 which is configured to perform one or more wireless device 22 functions as described herein such as with respect to wireless device behavior related to discarding protocol data unit (PDU) Set(s).

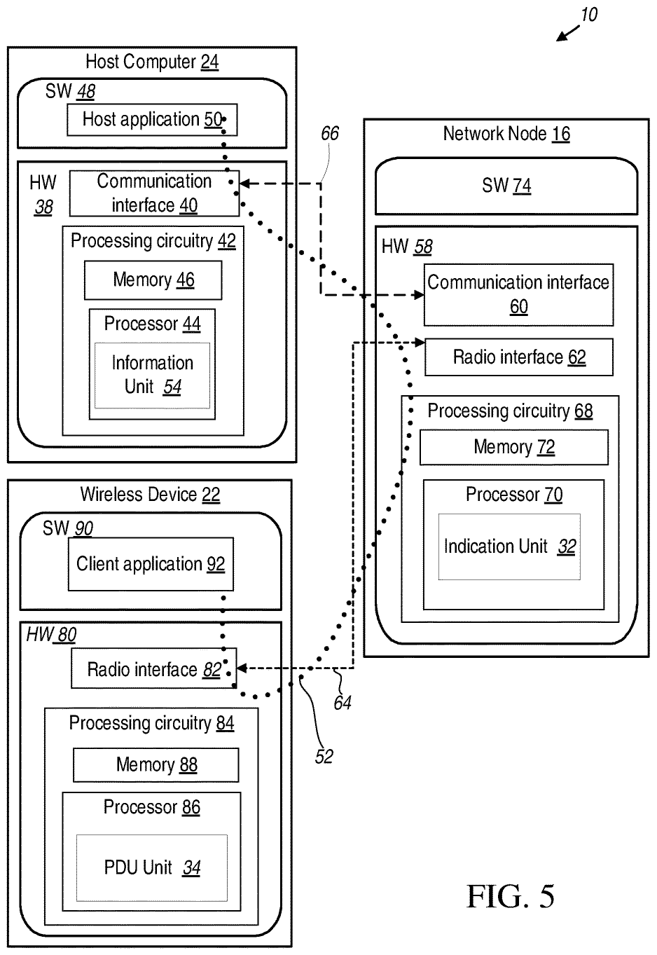

Example implementations, in accordance with an embodiment, of the WD 22, network node 16 and host computer 24 discussed in the preceding paragraphs will now be described with reference to FIG. 5. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to analyze, detect, store, transmit, receive, forward, relay, etc., information related to wireless device behavior related to discarding protocol data unit (PDU) Set(s), and/or perform one or more functions of indication unit 32 and/or PDU unit 34.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include indication unit 32 configured to that is configured to perform one or more network node 16 functions described herein such as those functions related to wireless device behavior related to discarding protocol data unit (PDU) Set(s).

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a PDU unit 34 configured to perform one or more wireless device 22 functions as described herein such as those functions related to wireless device behavior related to discarding protocol data unit (PDU) Set(s).

In some embodiments, the inner workings of the network node 16, WD 22, and host computer 24 may be as shown in FIG. 5 and independently, the surrounding network topology may be that of FIG. 4.

In FIG. 5, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 4 and 5 show various “units” such as indication unit 32, information unit 54 and PDU unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

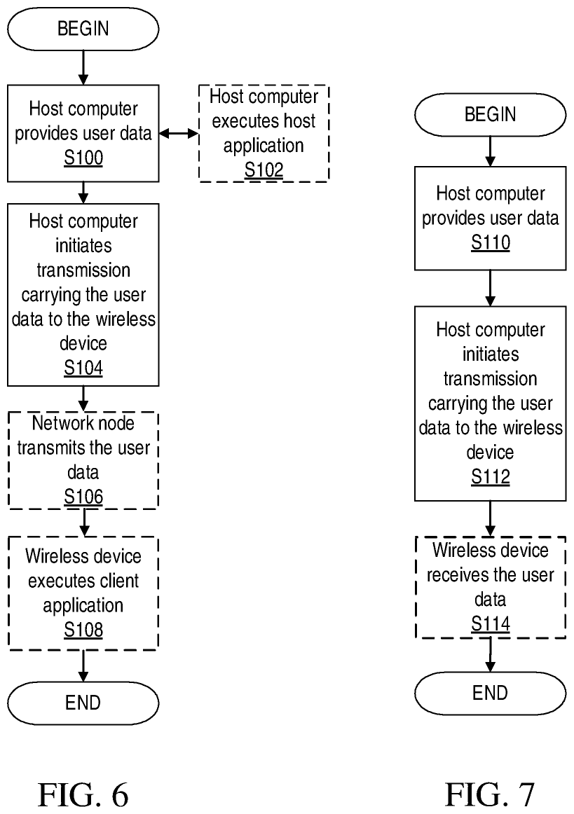

FIG. 6 is a flowchart illustrating an example method implemented in a communication system, such as, for example, the communication system of FIGS. 4 and 5, in accordance with one embodiment. The communication system may include a host computer 24, a network node 16 and a WD 22, which may be those described with reference to FIG. 5. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 7 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

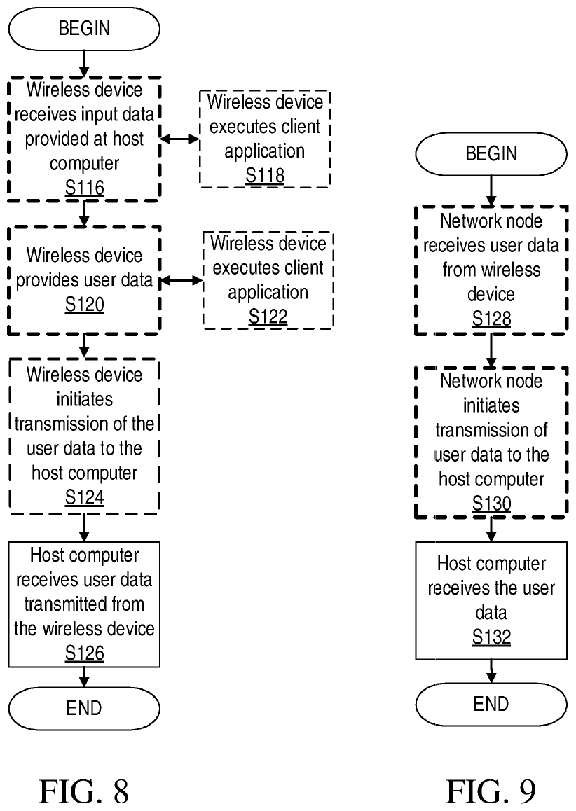

FIG. 8 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 9 is a flowchart illustrating an example method implemented in a communication system, such as, for example, the communication system of FIG. 4, in accordance with one embodiment. The communication system may include a host computer 24, a network node 16 and a WD 22, which may be those described with reference to FIGS. 4 and 5. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

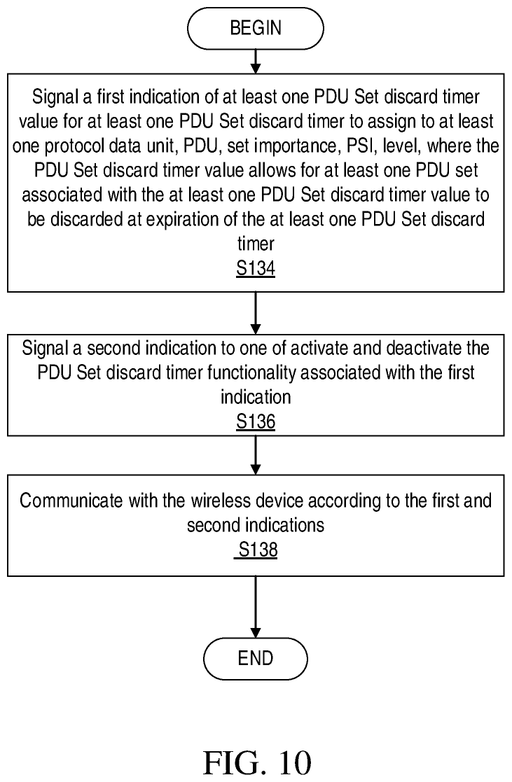

FIG. 10 is a flowchart of an example process in a network node 16 according to some embodiments of the present disclosure. One or more blocks described herein may be performed by one or more elements of network node 16 such as by one or more of processing circuitry 68 (including the indication unit 32), processor 70, radio interface 62 and/or communication interface 60. Network node 16 is configured to signal (Block S134) a first indication of at least one PDU Set discard timer value for at least one PDU Set discard timer to assign to at least one protocol data unit, PDU, set importance, PSI, level, where the PDU Set discard timer value allows for at least one PDU set associated with the at least one PDU Set discard timer value to be discarded at expiration of the at least one PDU Set discard timer, as described herein. Network node 16 is configured to signal (Block S136) a second indication to one of activate and deactivate the PDU Set discard timer functionality associated with the first indication, as described herein. Network node 16 is configured to communicate (Block S138) with the wireless device 22 according to the first and second indications.

According to one or more embodiments, the first indication is one of: an explicit indication that assigns the at least one PDU Set discard timer value to the at least one PSI level, and an implicit indication that that assign the at least one PDU Set discard timer value to the at least one PSI level by omitting an explicit assignment from the first indication.

According to one or more embodiments, the second indication is provided by one of: a Packet Data Convergence Protocol, PDCP, control element; medium access control, MAC, control element, CE; and open systems interconnection (OSI) Layer 1 (L1) signaling.

According to one or more embodiments, the second indication indicates one of: a plurality of PDU Set discard timer values for use with a PSI level; and a plurality of PSI levels that use a PDU Set discard timer value.

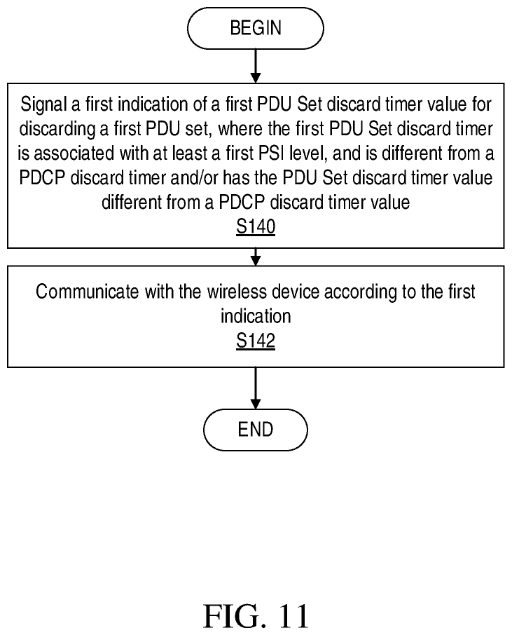

FIG. 11 is a flowchart of another example process in a network node 16 according to some embodiments of the present disclosure. One or more blocks described herein may be performed by one or more elements of network node 16 such as by one or more of processing circuitry 68 (including the indication unit 32), processor 70, radio interface 62 and/or communication interface 60. Network node 16 is configured to signal (Block S140) a first indication of a first protocol data unit, PDU, Set discard timer value for discarding a first PDU set, where the first PDU Set discard timer: is associated with at least a first PDU set importance, PSI, level, and is different from a packet data convergence protocol, PDCP, discard timer, and/or has the PDU Set discard timer value different from a PDCP discard timer value as described herein. Network node 16 is configured to communicate (Block S142) with the wireless device 22 according to the first indication, as described herein. According to one or more embodiments described herein, the first PDU Set discard timer may be a timer that is different from the PDCP discard timer value. According to one or more embodiments described herein, the first PDU Set discard timer value may operate in the PDCP.

According to one or more embodiments, the network node 16 is further configured to signal a second indication to the wireless device 22, where the second indication is configured to one of activate or deactivate the PDU Set discard timer functionality that is associated with the first indication.

According to one or more embodiments, the second indication is provided by one of: a Packet Data Convergence Protocol, PDCP, control element; or Layer 1 signaling.

According to one or more embodiments, the second indication is provided by a medium access control, MAC, control element, CE.

According to one or more embodiments, the second indication indicates a plurality of PDU Set discard timer values for use with a PSI level, the plurality of PDU Set discard timer values comprising the first PDU Set discard timer value.

According to one or more embodiments, the second indication indicates a plurality of PSI levels that use the first PDU Set discard timer value.

According to one or more embodiments, the first indication is an explicit indication that assigns the first PDU Set discard timer value to at least the first PSI level.

According to one or more embodiments, the first indication is an implicit indication that that assigns the first PDU Set discard timer value to at least the first PSI level by omitting an explicit assignment from the first indication.

According to one or more embodiments, the network node 16 is further configured to receive an indication of at least one PSI level supported by the wireless device 22.

According to one or more embodiments, the first PDU Set discard timer value is configured for use with a specific data radio bearer, DRB, PDCP, or service.

According to one or more embodiments, the first PDU Set discard timer value is configured for use with a plurality of data radio bearers, DRBs, or a plurality of services.

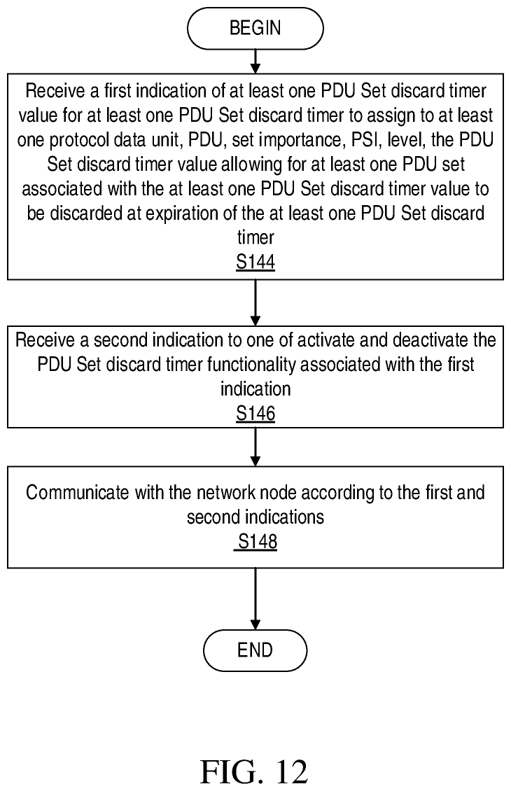

FIG. 12 is a flowchart of an example process in a wireless device 22 according to some embodiments of the present disclosure. One or more blocks described herein may be performed by one or more elements of wireless device 22 such as by one or more of processing circuitry 84 (including the PDU unit 34), processor 86, radio interface 82 and/or communication interface 60. Wireless device 22 is configured to receive (Block S140) a first indication of at least one PDU Set discard timer value for at least one PDU Set discard timer to assign to at least one protocol data unit, PDU, set importance, PSI, level, where the PDU Set discard timer value allows for at least one PDU set associated with the at least one PDU Set discard timer value to be discarded at expiration of the at least one PDU Set discard timer, as described herein. Wireless device 22 is configured to receive (Block S142) a second indication to one of activate and deactivate the PDU Set discard timer functionality associated with the first indication, as described herein. Wireless device 22 is configured to communicate (Block S144) with the network node 16 according to the first and second indications, as described herein.

According to one or more embodiments, the first indication is one of: an explicit indication that assigns the at least one PDU Set discard timer value to the at least one PSI level, and an implicit indication that that assign the at least one PDU Set discard timer value to the at least one PSI level by omitting an explicit assignment from the first indication.

According to one or more embodiments, the second indication is provided by one of: a Packet Data Convergence Protocol, PDCP, control element; medium access control, MAC, control element, CE; and Layer 1 signaling.

According to one or more embodiments, the second indication indicates one of: a plurality of PDU Set discard timer values for use with a PSI level; and a plurality of PSI levels that use a PDU Set discard timer value.

According to one or more embodiments, the processing circuitry 84 is further configured to: receive a PDU set, determine whether the PDU set has been assigned a PSI level based on the first and second indications, if no PSI level has been assigned to the PDU Set, start the at least one PDU Set Discard timer with the at least one PDU Discard timer value that is implicitly indicated in the first indication, and if a PSI level has been assigned to the PDU Set, start the at least one PDU Discard timer using the at least one PDU Discard timer value that is explicitly indicated in the first indication.

According to one or more embodiments, the processing circuitry 84 is further configured to determine whether to apply a configuration associated with the first indication to at least one PDU Discard timer that was running when the second indication was received.

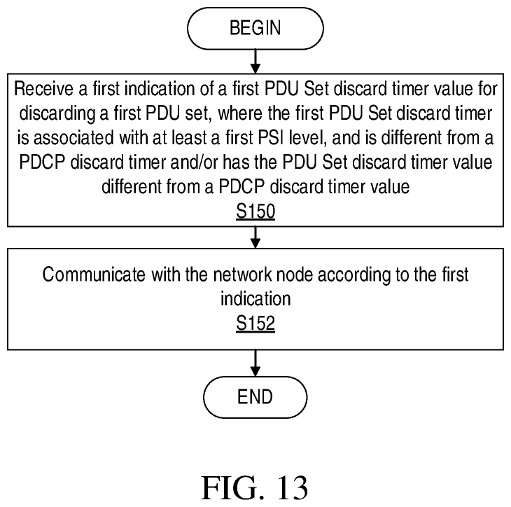

FIG. 13 is a flowchart of another example process in a wireless device 22 according to some embodiments of the present disclosure. One or more blocks described herein may be performed by one or more elements of wireless device 22 such as by one or more of processing circuitry 84 (including the PDU unit 34), processor 86, radio interface 82 and/or communication interface 60. Wireless device 22 is configured to receive (Block S150) a first indication of a first protocol data unit, PDU, Set discard timer value for discarding a first PDU set, where the first PDU Set discard timer: is associated with at least a first PDU set importance, PSI, level, and is different from a packet data convergence protocol, PDCP, discard timer, and/or has the PDU Set discard timer value different from a PDCP discard timer value, and communicate (Block S152) with the network node 16 according to the first indication. According to one or more embodiments described herein, the first PDU Set discard timer may be a timer that is different from the PDCP discard timer value. According to one or more embodiments described herein, the first PDU Set discard timer value may operate in the PDCP.

According to one or more embodiments, the wireless device 22 is further configured to receive a second indication, where the second indication is configured to one of activate or deactivate the PDU Set discard timer functionality that is associated with the first indication.

According to one or more embodiments, the second indication is received via one of: a PDCP control element; or Layer 1 signaling.

According to one or more embodiments, the second indication is received via a medium access control, MAC, control element, CE.

According to one or more embodiments, the second indication indicates a plurality of PDU Set discard timer values for use with a PSI level.

According to one or more embodiments, the second indication indicates a plurality of PSI levels that use the first PDU Set discard timer value.

According to one or more embodiments, the first indication is an explicit indication that assigns the first PDU Set discard timer value to at least the first PSI level.

According to one or more embodiments, the first indication is an implicit indication that assigns the first PDU Set discard timer value to at least the first PSI level by omitting an explicit assignment from the first indication.

According to one or more embodiments, the wireless device 22 is further configured to transmit an indication of at least one PSI level supported by the wireless device 22.

According to one or more embodiments, the first PDU Set discard timer value is configured to use with a specific data radio bearer, DRB, a PDCP, or service.

According to one or more embodiments, the first PDU Set discard timer value is configured for use with a plurality of data radio bearers, DRBs, or a plurality of services.

Having described the general process flow of arrangements of the disclosure and having provided examples of hardware and software arrangements for implementing the processes and functions of the disclosure, the sections below provide details and examples of arrangements for wireless device behavior related to discarding protocol data unit (PDU) Set(s).

Some embodiments provide wireless device behavior related to discarding protocol data unit (PDU) Set(s). One or more network node 16 functions described below may be performed by one or more of processing circuitry 68, processor 70, indication unit 32, etc. One or more wireless device 22 functions described below may be performed by one or more of processing circuitry 84, processor 86, PDU unit 34, etc.

The network node 16 can configure in the wireless device 22 a PDCP discard timer value. One timer will be started for each PDCP SDU which arrives to the PDCP layer. This timer starts when a PDCP SDU is received in the PDCP layer. When the timer expires, the PDCP layer discards the PDCP SDU and associated PDCP PDU. It has been suggested to have a PDU Set Discard timer. This timer is started when a first PDCP SDU belonging a certain PDU Set arrives to the PDCP layer. When this timer expires, all PDCP SDU packets associated to the PDU set are discarded. The network node 16 may configure a PDU Set Discard timer value for each PDCP entity, i.e., for each DRB, or it could configure one PDU Set Discard timer value for all DRBs, or if the PDU Set Discard timer value is not provided for a given DRB, the wireless device 22 does not configure and use the PDU Set Discard timer value for the DRB.

When a PDU Set Importance (PSI) indicator is used to differentiate PDU Set discarding treatment, the wireless device 22 may have a PDU Set Discard timer value (one or multiple) for different PSI levels. One PDU Set Discard timer will be started for each PDU Set for which a PDU Set Discard timer value has been configured and selected.

### 1) Configuration Signaling to the Wireless Device 22

The network node 16 may associate one PSI level to one (or multiple) PDU Set discard timer value implicitly or explicitly. These values may be specific to the PDU Sets in a given DRB/PDCP, per service, or for all configured services/DRBs in the wireless device 22.

The network node 16 does not need to associate all PSI levels to a PDU Set discard timer value. Those PSI levels which did not get assigned an explicit PDU set discard timer value, implicitly set the PDU Set discard timer value to infinite, a default value, or it would imply that the timer is not configured for the PSI level.

These scenarios can be also applicable to the case that the network node 16 associates one PDU set discard timer value with one or more PSI levels. In this case, the same PDU set discard timer value is used for packets with a different PSI level.

In addition, the association between one or more PSI levels and one or more PDU set discard timer values can be built based on the wireless device indication on the available/supported PSI levels when a connection is established. If there is an explicit report from wireless device 22 about the change of available/supported PSI levels, a network node 16 may reconfigure the association between the indicated PSI levels and the discard timer values.

The network node 16 may also indicate whether PDU Set discard timer per PSI functionality should be activated or deactivated.

### 2) Feature Activation/Deactivation

The network, such as via network node 16, may further use a PDCP Control Element or MAC CE to further activate and deactivate the use of the PSI specific PDU Set Discard timer functionality which already has preconfigured the association between PSI levels and timer values. The activation can also include, the PSI levels for which their associated PDU Set Discard timer should be used, an indication of which of the PDU Set Discard timer values that should be selected for a PSI if multiple timer values are configured for that PSI, or both. If there are multiple PSI levels associated with one timer value, the activation can indicate which PSI levels should use the timer value.

The activation of the feature may be triggered by the distributed unit (DU) or by the central unit (CU). If it is triggered by the CU and PDCP CE is used, then the CU will build the PDCP CE or RRC message to send to the wireless device 22. If MAC CE is used, the CU will inform the DU via F1 interface and the DU will then send the MAC CE. A confirmation indication may be sent back from the DU to the CU in F1. If the activation is triggered by the DU and PDCP CE is used, the DU will indicate to the CU via F1 to send the PDCP CE or RRC message to the wireless device 22. A confirmation message may be sent to the DU by the CU. If MAC CE is used for this purpose, the DU can build the MAC-CE and may also indicate to the CU whether the feature was activated or deactivated.

Another option for using PDCP CE or MAC CE, is to use inband signaling together with the user plane data. “R”-bits (reserved) bits may be used in the PDCP header to indicate the activation or deactivation. As above, the DU or CU could trigger the activation or deactivation of the feature. There could be specific network implementations in which the DU triggers the activation and deactivation but the DU does not indicate anything to the CU. The DU would change the PDCP PDU header to activate and deactivate the feature.

In some embodiments, activation/deactivation may be provided via L1 signaling, e.g., DCI in PDCCH. In this case, a wireless device 22 can apply the feature as soon as L1 signaling is received or can start to apply it after a certain offset time duration.

### 3) Wireless Device 22 Behavior

When the feature is/was activated and one, e.g., the first, PDCP SDU belonging to a new PDU Set arrives to the PDCP layer, wireless device 22 first identifies the PDU Set and then determines whether the PDU Set has been assigned a PSI level or not. These identification and assigning depends on the wireless device capabilities and wireless device configuration.

If no PSI level is assigned to that PDU Set, wireless device 22 starts the PDU Set Discard timer with the value indicated when no PSI level is used.

If a PSI level is assigned to that PDU Set, wireless device 22 checks whether the network, such as via network node 16, configured a PDU Set discard timer value for the PSI level.
a) If no timer value was configured, there are two options. A first option is that wireless device 22 does not start the PDU Set discard timer for the PDU set, or it sets the timer value to infinity (or a large value that is unlikely to occur). A second option is that wireless device 22 starts the PDU set discard timer with a default value if it was configured by the network node 16.
b) If one timer value was configured, the wireless device 22 starts the PDU Set discard timer value using the value indicated by the network node 16 for the PSI level.
c) If multiple timer values were configured for the PSI level, wireless device 22 checks if the activation signal includes an indication of which timer value to use. If there was no indication then wireless device 22 use the timer value that was configured as first priority, e.g., the first timer value in the list (e.g., list ordered by priority).

There may be situations in which wireless device 22 receives an activation or deactivation command and there were PDU Sets which had PDU Set discard timers running. In this case(s):
a) Wireless device 22 applies the new configuration for the newly received PDU Sets and does not affect the PDU Set timers which are already running.
b) Wireless device 22 applies the new configuration for the PDU Sets arrived since a certain time threshold, which can be also network-configured.
c) Wireless device 22 determines for each PDU set which PDU Set discard timer was running, the PSI level. If no PSI level was assigned, wireless device 22 does not take any action for that PDU Set. If a PSI level was assigned, wireless device 22 determines if a PDU Set timer value was assigned for the PSI level:
   a. If no timer value was assigned, wireless device 22 does not take any action
   b. If a value was assigned, wireless device 22 1) re-starts the PDU Set timer with the new value, or 2) re-starts the PDU Set timer with the smallest value between the new value and the time left the timer had.

Activation can be used to update the association between PSI levels and timer values when there is a need, e.g., new report of change in the available PSI levels. For example, wireless device 22 can start to use new timer values for the PSIs which are already activated with some timer values previously when it receives another timer values.

Similarly, wireless device 22 stops to use time values for the indicated PSIs if the deactivation signaling specifies some PSI levels not to use the timer values while not indicated PSI levels that are activated still keep using the timer values.

When the PDU Set discard timer value expires, wireless device 22 discards all PDCP SDUs and PDUs associated to the PDU Set. If the new applied PDU Set discard timer makes an already running discard timer to expire the expiration and discarding should take effect immediately.

Hence, one or more embodiments described herein allows using the PSI indicator to discard PDU Sets with different priority levels in different ways in different scenarios, e.g., congestion situations, such that congestion in the network may be at least in part alleviated.

### Some Examples

Embodiment A1. A network node 16 configured to communicate with a wireless device 22 (WD 22), the network node 16 configured to, and/or comprising a radio interface 62 and/or comprising processing circuitry 68 configured to:
signal a first indication of at least one PDU Set discard timer value for at least one PDU Set discard timer to assign to at least one protocol data unit, PDU, set importance, PSI, level, the PDU Set discard timer value allowing for at least one PDU set associated with the at least one PDU Set discard timer value to be discarded at expiration of the at least one PDU Set discard timer; and
signal a second indication to one of activate and deactivate the PDU Set discard timer functionality associated with the first indication; and
communicate with the wireless device 22 according to the first and second indications.

Embodiment A2. The network node 16 of Embodiment A1, wherein the first indication is one of:
an explicit indication that assigns the at least one PDU Set discard timer value to the at least one PSI level; and
an implicit indication that that assign the at least one PDU Set discard timer value to the at least one PSI level by omitting an explicit assignment from the first indication.

Embodiment A3. The network node 16 of Embodiment A1, wherein the second indication is provided by one of:
a Packet Data Convergence Protocol, PDCP, control element;
medium access control, MAC, control element, CE; and
Layer 1 signaling.

Embodiment A4. The network node 16 of Embodiment A1, wherein the second indication indicates one of:
a plurality of PDU Set discard timer values for use with a PSI level; and
a plurality of PSI levels that use a PDU Set discard timer value.

Embodiment B1. A method implemented in a network node 16, the method comprising:
signaling a first indication of at least one PDU Set discard timer value for at least one PDU Set discard timer to assign to at least one protocol data unit, PDU, set importance, PSI, level, the PDU Set discard timer value allowing for at least one PDU set associated with the at least one PDU Set discard timer value to be discarded at expiration of the at least one PDU Set discard timer; and
signaling a second indication to one of activate and deactivate the PDU Set discard timer functionality associated with the first indication; and
communicating with the wireless device 22 according to the first and second indications.

Embodiment B2. The method of Embodiment B1, wherein the first indication is one of:
an explicit indication that assigns the at least one PDU Set discard timer value to the at least one PSI level; and
an implicit indication that that assign the at least one PDU Set discard timer value to the at least one PSI level by omitting an explicit assignment from the first indication.

Embodiment B3. The method of Embodiment B1, wherein the second indication is provided by one of:
a Packet Data Convergence Protocol, PDCP, control element;
medium access control, MAC, control element, CE; and
Layer 1 signaling.

Embodiment B4. The method of Embodiment B1, wherein the second indication indicates one of:
a plurality of PDU Set discard timer values for use with a PSI level; and
a plurality of PSI levels that use a PDU Set discard timer value.

Embodiment C1. A wireless device 22 configured to communicate with a network node 16, the WD 22 configured to, and/or comprising a radio interface 82 and/or processing circuitry 84 configured to:

receive a first indication of at least one PDU Set discard timer value for at least one PDU Set discard timer to assign to at least one protocol data unit, PDU, set importance, PSI, level, the PDU Set discard timer value allowing for at least one PDU set associated with the at least one PDU Set discard timer value to be discarded at expiration of the at least one PDU Set discard timer; and
receive a second indication to one of activate and deactivate the PDU Set discard timer functionality associated with the first indication; and
communicate with the network node 16 according to the first and second indications.

Embodiment C2. The wireless device 22 of Embodiment C1, wherein the first indication is one of:
an explicit indication that assigns the at least one PDU Set discard timer value to the at least one PSI level; and
an implicit indication that that assign the at least one PDU Set discard timer value to the at least one PSI level by omitting an explicit assignment from the first indication.

Embodiment C3. The wireless device 22 of Embodiment C1, wherein the second indication is provided by one of:
a Packet Data Convergence Protocol, PDCP, control element;
medium access control, MAC, control element, CE; and
Layer 1 signaling.

Embodiment C4. The wireless device 22 of Embodiment C1, wherein the second indication indicates one of:
a plurality of PDU Set discard timer values for use with a PSI level; and
a plurality of PSI levels that use a PDU Set discard timer value.

Embodiment C5. The wireless device 22 of Embodiment C1, wherein the processing circuitry 84 is further configured to:
receive a PDU set;
determine whether the PDU set has been assigned a PSI level based on the first and second indications;
if no PSI level has been assigned to the PDU Set, start the at least one PDU Set Discard timer with the at least one PDU Discard timer value that is implicitly indicated in the first indication; and
if a PSI level has been assigned to the PDU Set, start the at least one PDU Discard timer using the at least one PDU Discard timer value that is explicitly indicated in the first indication.

Embodiment C6. The wireless device 22 of Embodiment C1, wherein the processing circuitry 84 is further configured to determine whether to apply a configuration associated with the first indication to at least one PDU Discard timer that was running when the second indication was received.

Embodiment D1. A method implemented in a wireless device 22 that is configured to communicate with a network node 16, the method comprising:
receiving a first indication of at least one PDU Set discard timer value for at least one PDU Set discard timer to assign to at least one protocol data unit, PDU, set importance, PSI, level, the PDU Set discard timer value allowing for at least one PDU set associated with the at least one PDU Set discard timer value to be discarded at expiration of the at least one PDU Set discard timer; and
receiving a second indication to one of activate and deactivate the PDU Set discard timer functionality associated with the first indication; and
communicating with the network node 16 according to the first and second indications.

Embodiment D2. The method of Embodiment D1, wherein the first indication is one of:
an explicit indication that assigns the at least one PDU Set discard timer value to the at least one PSI level; and
an implicit indication that that assign the at least one PDU Set discard timer value to the at least one PSI level by omitting an explicit assignment from the first indication.

Embodiment D3. The method of Embodiment D1, wherein the second indication is provided by one of:
a Packet Data Convergence Protocol, PDCP, control element;
medium access control, MAC, control element, CE; and
Layer 1 signaling.

Embodiment D4. The method of Embodiment D1, wherein the second indication indicates one of:
a plurality of PDU Set discard timer values for use with a PSI level; and
a plurality of PSI levels that use a PDU Set discard timer value.

Embodiment D5. The method of Embodiment D1, further comprising:
receiving a PDU set;
determining whether the PDU set has been assigned a PSI level based on the first and second indications;
if no PSI level has been assigned to the PDU Set, starting the at least one PDU Set Discard timer with the at least one PDU Discard timer value that is implicitly indicated in the first indication; and
if a PSI level has been assigned to the PDU Set, starting the at least one PDU Discard timer using the at least one PDU Discard timer value that is explicitly indicated in the first indication.

Embodiment D6. The method of Embodiment D1, further comprising determining whether to apply a configuration associated with the first indication to at least one PDU Discard timer that was running when the second indication was received.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AR | Augmented Reality |
| DCI | Downlink Control Information |
| DL | Downlink |
| DRB | Dedicated Radio Bearer |
| eMBB | Enhanced Mobile BroadBand |
| Fps | Frames Per Second |
| IP | Internet Protocol |
| KB | Kilobytes |
| L1 | Layer 1 |
| MR | Mixed Reality |
| NR | New Radio |
| PDCCH | Physical Dedicated Control Channel |
| PDCP | Packet Data Convergence Protocol |
| PDU | Protocol Data Unit |
| PSI | PDU Set Importance |
| RAN | Radio Access Network |
| RLC | Radio Link Controller |
| RRC | Radio Resource Controller |
| SDU | Service Data Unit |
| TB | Transport Block |
| TTI | Time Transmission Interval |
| UE | User Equipment |
| UL | Uplink |
| URLLC | Ultra-Reliable Low Latency Communications |
| VoIP | Voice over IP |
| VR | Virtual Reality |
| XR | eXtended Reality |
| 3GPP | 3rd Generation Partnership Project |
| 5GC | 5G Core |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented by a wireless device that is configured to communicate with a network node, the method comprising:
receiving a first indication of a first protocol data unit, PDU, Set discard timer value for discarding a first PDU set, the first PDU Set discard timer being associated with at least a first PDU set importance, PSI, level;
determining that an arrived PDU Set has been assigned to the first PDU set importance level, and starting the PDU Set discard timer value using the indication for the said PSI level; and
communicating with the network node according to the first indication.

2. The method of claim 1, further comprising receiving a second indication, the second indication is configured to one of activate or deactivate the PDU Set discard timer functionality that is associated with the first indication.

3. The method of claim 2, wherein the second indication is received via one of:
a PDCP control element;
Layer 1 signaling; and
a medium access control, MAC, control element, CE.

4. (canceled)

5. The method of claim 2, wherein the second indication indicates a plurality of PDU Set discard timer values for use with a PSI level.

6. The method of claim 2, wherein the second indication indicates a plurality of PSI levels that use the first PDU Set discard timer value.

7. The method of claim 1, wherein a plurality of the first indication is an explicit indication that assigns the first PDU Set discard timer value to at least the first PSI level.

8. The method of claim 1, wherein the first indication is an implicit indication that assigns the first PDU Set discard timer value to at least the first PSI level by omitting an explicit assignment from the first indication.

9. The method of claim 1, further comprising transmitting an indication of at least one PSI level supported by the wireless device.

10. The method of claim 1, wherein the first PDU Set discard timer value is configured to use with a specific data radio bearer, DRB, a PDCP, or service.

11. The method of claim 1, wherein the first PDU Set discard timer value is configured for use with a plurality of data radio bearers, DRBs, or a plurality of services.

12. A wireless device configured to communicate with a network node, the wireless device is configured to:
receive a first indication of a first protocol data unit, PDU, Set discard timer value for discarding a first PDU set, the first PDU Set discard timer being associated with at least a first PDU set importance, PSI, level; and
determine that an arrived PDU Set has been assigned to the first PDU set importance level, and starting the PDU Set discard timer value using the indication for the said PSI level; and
communicate with the network node according to the first indication.

13.-22. (canceled)

23. A method in a network node configured to communicate with a wireless device, the method comprising:
signaling a first indication of a first protocol data unit, PDU, Set discard timer value for discarding a first PDU set, the first PDU Set discard timer being associated with at least a first PDU set importance, PSI, level; and
communicating with the wireless device according to the first indication.

24. The method of claim 23, further comprising signaling a second indication to the wireless device, the second indication is configured to one of activate or deactivate the PDU Set discard timer functionality that is associated with the first indication.

25. The method of claim 24, wherein the second indication is provided by one of:
a Packet Data Convergence Protocol, PDCP, control element;
Layer 1 signaling; and
medium access control, MAC, control element, CE.

26. (canceled)

27. The method of claim 24, wherein the second indication indicates a plurality of PDU Set discard timer values for use with a PSI level, the plurality of PDU Set discard timer values comprising the first PDU Set discard timer value.

28. The method of claim 24, wherein the second indication indicates a plurality of PSI levels that use the first PDU Set discard timer value.

29. The method of claim 23, wherein the first indication is an explicit indication that assigns the first PDU Set discard timer value to at least the first PSI level.

30. The method of claim 23, wherein the first indication is an implicit indication that that assigns the first PDU Set discard timer value to at least the first PSI level by omitting an explicit assignment from the first indication.

31. The method of claim 23, further comprising receiving an indication of at least one PSI level supported by the wireless device.

32. The method of claim 23, wherein the first PDU Set discard timer value is configured for use with a specific data radio bearer, DRB, PDCP, or service.

33. The method of claim 23, wherein the first PDU Set discard timer value is configured for use with a plurality of data radio bearers, DRBs, or a plurality of services.

34. A network node configured to communicate with a wireless device, the network node configured to:
signal a first indication of a first protocol data unit, PDU, Set discard timer value for discarding a first PDU set, the first PDU Set discard timer being associated with at least a first PDU set importance, PSI, level; and
communicate with the wireless device according to the first indication.

35.-44. (canceled)
